(19) United States
(12) Patent Application Publication
(10) Pub. No.: US 2003/0233440 A1
(43) Pub. Date: Dec. 18, 2003

(54) Network system including host server and method of setting up host server

(75) Inventors: Taku Nakamura, Yokohama (JP); Naoki Yamamoto, Yokohama (JP); Takuya Imaide, Fujisawa (JP)

Correspondence Address: Townsend and Townsend and Crew LLP, 8th Floor, Two Embarcadero Center, San Francisco, CA, 94111, US

(73) Assignee: Hitachi, Inc., Tokyo (JP)

(21) Appl. No.: 10/348,933

(22) Filed: Jan. 21, 2003

(30) Foreign Application Priority Data
Jun. 18, 2002 (JP) 2002-176543

(51) Int. Cl. G06F 15/173

(52) U.S. Cl. 709/223

(57) ABSTRACT

A method for managing a network system including at least one host system and a registration server provided at a remote location from the at least one host system, the at least one host system and the registration server being coupled to each other by a communication link, includes receiving at the registration server a first request to register a first administrator of a first host system, the first administrator being provided with authority to control access to the first host system by one or more users, the first host system being associated with a first entity. Validity of the first registration request is authenticated at the registration server. The first registration request is considered valid if valid first authorization information is provided to the registration server in connection with the first registration request. The registration server is associated with an entity that is different from the first entity. The first administrator is registered as an administrator of the first host system upon successfully authenticating the first registration request.

### CROSS-REFERENCES TO RELATED APPLICATIONS

The present application is related to and claims priority from Japanese Patent Application No. 2002-176543, filed on Jun. 18, 2002.

### BACKGROUND OF THE INVENTION

The present invention relates to a server coupled to an external network and an internal network.

The prior art concerning a server connected between an external network and an internal network is described in, for example, Japanese Patent Laid-open No. 2002-56074. This publication describes the server in which when a contract user starts to use installed equipment 3, the server accesses an authentication server 2 through a communication network N1, transmits an authentication request information accompanying a home ID, receives authentication permission information in response to the above request, and releases the equipment usage lock of the equipment 3 based on the authentication permission information. In addition, when the user finishes the usage of the equipment, he resets the lock and transmits the termination notification information including the track record of the usage of equipment to the authentication server 2.

The main target of the technology described in the publication lies on lease companies and, more specifically, the leased equipment is managed through the network and the home information server. It does not relate to the security and servicing of the home network. For example, some important information might possibly be stored in the leased equipment, and therefore, unauthorized access to the information from the external must be prevented. On the other hand, since the leased equipment is connected to the network, if serviceability is taken into consideration, the equipment can conveniently be controlled remotely. In the system mentioned in the above publication, authentication is performed through the access to the external authentication server, this is not for the purpose of maintaining security of the home network or keeping its serviceability. It is solely to allow a lease company to be able to correctly grasp the condition of the leased equipment.

In the case of a network system, it is important to provide high security and good serviceability. In the past, there has been a problem that if priority is given to the high degree of security, it degrades the serviceability, and if priority is given to the good serviceability, the level of security is lowered.

For example, a firewall is provided in a server to prevent an authorized access from an external network. In order to properly install it and provide a high level of security, a skilled personnel required. If a person having insufficient knowledge installs a security system, a high level of security may not be maintained. Even if a person who has a sufficient knowledge of the security system builds the system that requires complicated procedures to heighten the degree of security, the serviceability of the system may be lowered as a result. In addition, even if the person who having sufficient knowledge sets the security system, when the outsider directly accesses the internal network, rather than an external network, the setting of the server might be changed to a low security one from the inside of the server.

There is known the authentication method that uses biological information, such as fingerprints or irises, in order to prevent the outsider from directly accessing the internal network. When the biological information is used for authentication, the outsider is unable to access the internal network. However, if the biological information exists inside the server, the information might be changed without authorization by a third party. In this case, the security of the network will be substantially degraded. For example, the intruder may retrieve a method of making the setting of the firewall invalid and make the internal network freely accessible from outside. Therefore, it is safer to store the authentication information on the outside where rewrite is not easy.

However, it is not a proper method to keep the biological information of all users utilizing the internal network outside. For example, if one utilizes the biological information registered in an external center when he intends to access the information in the internal network, one has to bear some communication cost every time he requests authentication, and also considering the time spent for obtaining authentication the above method will be disadvantageous. Further, there is some sentimental resistance to the registration of the biological information of all users of the internal network to the center being an outside organ. Such a system may be said to have poor serviceability.

### BRIEF SUMMARY OF THE INVENTION

One embodiment of the present invention provides a network system having both a high degree of security and good serviceability.

In one embodiment, a method for managing a network system including at least one host system and a registration server provided at a remote location from the at least one host system, the at least one host system and the registration server being coupled to each other by a communication link, includes receiving at the registration server a first request to register a first administrator of a first host system, the first administrator being provided with authority to control access to the first host system by one or more users, the first host system being associated with a first entity. Validity of the first registration request is authenticated at the registration server. The first registration request is considered valid if valid first authorization information is provided to the registration server in connection with the first registration request. The registration server is associated with an entity that is different from the first entity. The first administrator is registered as an administrator of the first host system upon successfully authenticating the first registration request.

In another embodiment, a method for managing a host system coupled to a registration server provided at a remote location from the host system, the host system and the registration server being coupled to each other by a communication link, the method comprising: transmitting a registration request for registering a first administrator of the host system to the registration server, the first administrator being provided with authority to control access to the host system by one or more users, the host system being associated with a first entity; providing authorization information to authenticate the registration request to the registration server, the registration server being associated with an entity that is different from the first entity, the registration server being configured to authenticate requests to register administrators of a plurality of host systems, each of the plurality of host systems being associated with a different entity from each other and the entity associated with the registration server; and receiving approval of the registration request from the registration server.

In another embodiment, a host server provided in a host system for managing access to the host system, the host server being coupled to a remote registration server, the host server comprising: a first communication interface coupled to an internal network provided within the host system; a second communication interface coupled to an external network, the external network coupling the host server to the remote registration server; an information processing unit to process requests received from the internal network or from a user terminal regarding access to one or more electronic devices provided within the host system; and a computer readable medium. The computer medium includes code for transmitting a request to register a first administrator of the host system to the remote registration server, the first administrator being provided with authority to control access to the host system by one or more users; code for providing authorization information to authenticate the request to register the first administrator to the remote registration server; and code for receiving approval of the request to register the first administrator from the registration server. The host system is associated with a first entity and the remote registration server is associated with a second entity different from the first entity.

In yet another embodiment, a network system includes a first host system including a first host server and a first electronic device coupled to the first host server via a first internal network, the first host system being associated with a first administrator having authority to control access to the first host system by one or more users, the first host system being associated with a first entity; a second host system including a second host server and a second electronic device coupled to the second host server via a second internal network, the second host system being associated with a second administrator having authority to control access to the second host system by one or more users, the second host system being associated with a second entity; a remote management server coupled to the first and second host systems via an external network, the remote management server including first authentication information used for authenticating a request from the first administrator relating to the first host system and second authentication information used for authenticating a request from the second administrator relating to the second host system, the remote management server being associated with a third entity. The first, second, and third entities are different entities from each other.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a first embodiment according to the present invention;

FIG. 2 illustrates a process flow of registering an administrator of a home information server of FIG. 1;

FIG. 3 illustrates a process flow when a general user accesses a file shown in the first embodiment according to the present invention;

FIG. 4 illustrates authentication information of an administrator of a home information server managed by a company of a home information server in a second embodiment according to the present invention;

FIG. 5 illustrates procedures involved in adding a piece of equipment to an internal network shown in a third embodiment according to the present invention;

FIG. 6 is a block diagram illustrating an implementation of embodiments of the present invention, as applied to an HDD recorder;

FIG. 7 shows the internal configuration of a home information server according to one embodiment of the present invention; and

FIG. 8 shows part of a setting file of a server according to one embodiment of the present invention.

### DETAILED DESCRIPTION OF THE INVENTION

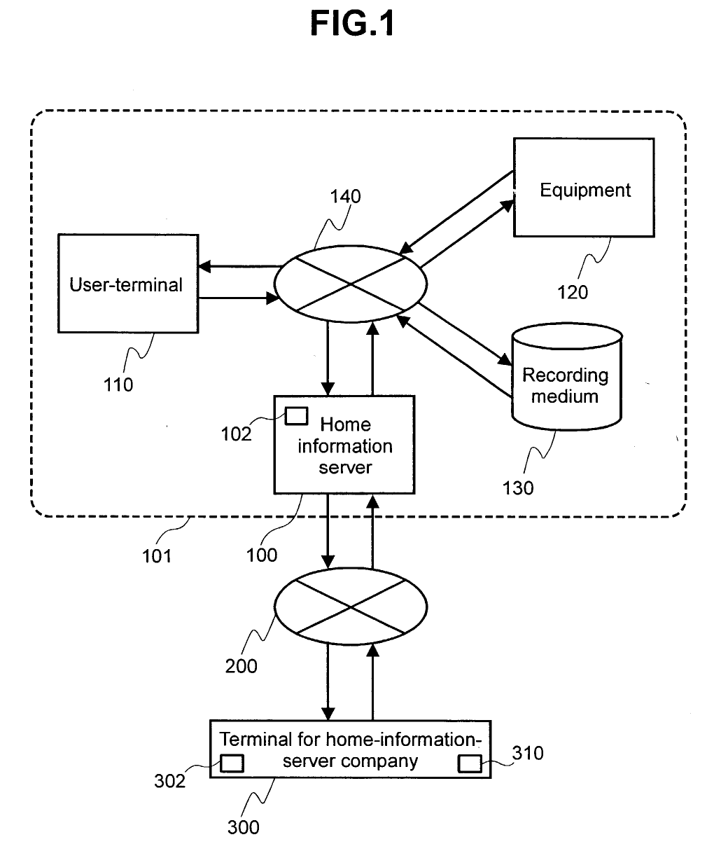

FIG. 1 shows a host system 101 includes an internal network 140 according to the present embodiment. The internal network 140 is a network having a limited range, provided within homes, enterprises, shops or facilities, for example, a local area network (LAN). On the other hand, an external network 200 denotes an open network, e.g., the Internet, in which many and unspecified persons are able to freely communicate therewith. A host server 100 is connected between the internal network and the external network.

The present embodiment is described using a home network as the internal network and a home information server (or host server or home server) 100. However, the present embodiment is not limited to such a case. The home server 100 includes a management agent 102 stored in a computer readable medium to perform authorization and administrative functions within the host system 101, as will be explained below.

A user terminal 110 is used for the users of the internal network 140 to access the equipment or files existing in the network. The user terminal is a PC or a PDA, for example. The equipment for authenticating users (password input device or means or biological information input device or means) is coupled to or included in the user terminal 110. The equipment for authentication (or authentication device) may be connected to any device within the host system 101 or may be connected directly to the home information server 100. The equipment for authentication also functions as an authentication-information-input means for inputting the authentication information to be transmitted to a remote registration server (or terminal for home-information-server company) 300 that is operated or managed by an entity that is not associated with the owner of the host system 101. The remote server 300 includes a registration agent 302, stored in a computer readable medium, to cooperate with the management agent 102 in registering an administrator of the host system 101 and other administrative functions described herein. In one embodiment, the remote server 300 is coupled to a plurality of host systems.

The authentication device also functions as the user-authentication-information-input means for inputting the user authentication information to be transmitted to the home information server in order that the general user may use a piece of equipment 120 (e.g., one or more of consumer electronic devices) connected to the internal network. The equipment for authentication may be the equipment for inputting characters like a keyboard or a reader for reading biological information such as fingerprints or irises. In the figure, the equipment 120 illustrates as a single unit of equipment for simplification, but generally comprises a plurality of devices (e.g., television, video cassette recorder, and air conditioner) coupled to the internal network 140.

A recording medium 130 has an area for recording the data on the internal network. For example, the recording medium 130 is an HDD or a DVD. In the figure, for simplification, the recording medium 130 is depicted as one unit of equipment but generally a plurality of units of equipment is connected to the internal network 140.

In the present figure, the user terminal 110, the equipment 120 and the recording medium 130 are shown as separate units, but two or more of these units may be combined into one unit in some cases.

The internal network 140 is used as a communication path for the user terminal 110, the equipment 120, and the recording medium 130. The home information server 100 manages the user terminal 110, the equipment 120, and the recording medium 130, any of which is connected to the internal network 140. The home server 100 manages communication among the user terminals 110, the units of equipment, and the recording media, and the authentication of users. In short, control signals exchanged among them through the communication path 100 are controlled by the home information server. The home information server 100 also has a function of a firewall which refuses an unauthorized access requested from the external network 200. In other words, control signals sent from the external network to the internal network are selected based on the specified conditions. Thus, the home information server 100 comprises a control-signal-selection means or control signal selector, which is able to select the control signals exchanged among a plurality of units of equipment connected to the internal network and the control signals sent from the external network to the plurality of units of equipment based on the specified conditions.

The terminal 300, which is provided in the information center in a remote location, connected to an home information server via the external network 200 is used for configuring the home information server 100 through the external network by a home-information-server company. The configuration of the home information server includes information on the specified conditions that are used to select control signals. A setting-request-input means, which is used for inputting a setting or configuration request, is connected to the user terminal or the home information server. The setting-request-input means inputs instructions on how to set the specified conditions, and the instructions are transmitted to the center as a setting request through the home information server. The center replies to the home information center with the setting information corresponding to the setting request. Upon receiving the setting information, the home information server sets the approval condition based on the setting information. The home information server is provided with a setting means for setting the specified conditions based on the setting information.

In other words, the home information server may be configured such that it transmits the authentication information input through the equipment for authentication to the center and receives the authentication-confirmation information showing that the transmitted authentication information has been authenticated properly, and when it receives the authentication-confirmation information, it becomes possible to set the specified conditions. This is an effective configuration in a case where a person having enough knowledge intends to set the given condition as he wishes, the description of the specified conditions is finally authenticated by someone outside, so that the security of the system can be high and the specified conditions is also satisfied.

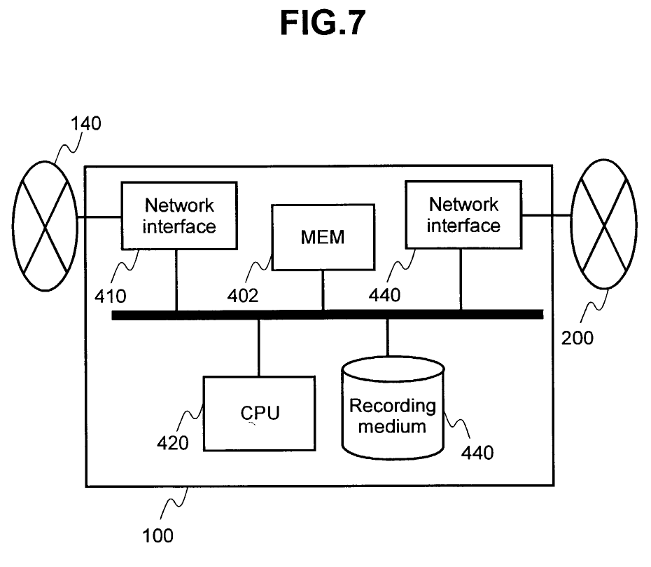

FIG. 7 shows a configuration of a home information server 100 according to one embodiment of the present invention. In the figure, the internal network 140 and the external network 200 are the same as those shown in FIG. 1, so that like reference numerals are given to like parts and the explanation thereof is omitted.

A first network interface 410 is coupled to the internal network to exchange data with the internal network 140. A second network interface 430 is coupled to the external network to exchange data with the external network 200. A recording medium 440 stores the authentication information of the users of the internal network and the specified conditions used for the selection of control signals.

The CPU 420 performs the authentication of the internal users, the selection of the control signals exchanged among the units of equipment connected to the internal network and of the control signals sent to the internal network from the external network, and the communication control with the terminal for the home-information-server company 300. The CPU 420 generates specified conditions, corresponding to the above-mentioned setting information, in a storage medium or updates the stored specified conditions.

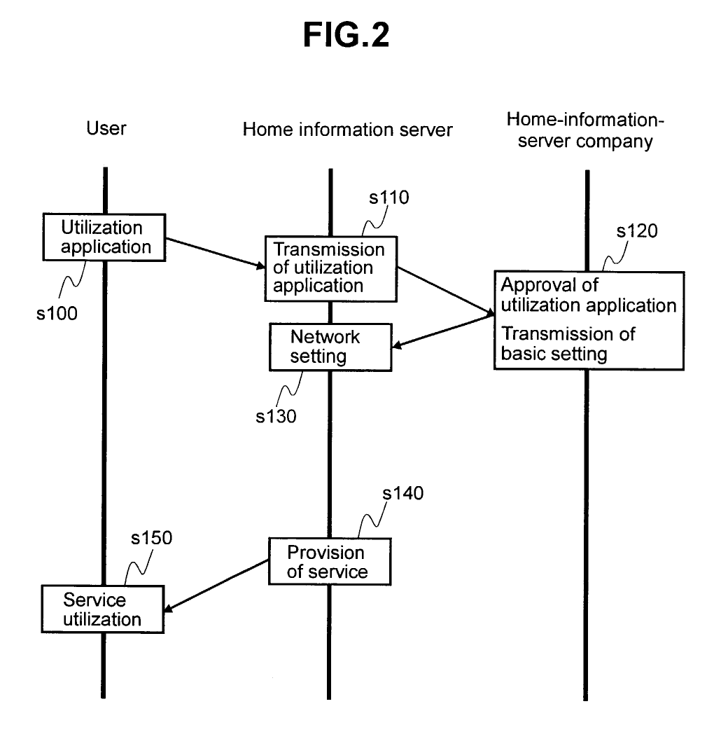

Next, the registration of the administrator of the home information server, which is the initial procedure of setting the home information server 100, will be explained referring to FIG. 2. The purchaser of the home information server 100 will register the administrator of the home information server to be the representative of the internal network 140 to the home-information-server company. The administrator of the home information server is different from the general user, it comprises the authority to add a general user or users and also the authority to inspect, change or delete the files made by the general users on the internal network 140.

The purchaser of the home information server 100 performs utilization application through the user terminal (step S100). In this case, in order to authenticate the administrator of the home information server, the user transmits his password having a sufficient degree of cipher strength or transmits biological information represented by a fingerprint or iris. The home information server 100 receives the above-mentioned password etc. and transmits them to the home-information-server-company terminal 300 (step S110). The home-information-server company receives the password through the home-information-server-company terminal 300 (step S120). After that, the home-information-server administrator is registered on the terminal for a home-information-server company (step S130).

After the registration of the administrator of the home information server, the home-information-server company transmits a basic service setting provided by the home information server 100. The contents set at this place are to make the equipment 120 and the recording medium 130 connected to the internal network 140 utilizable inside the network, and to set a firewall to separate the internal network 140 from the external network 200. The home information server 100, after it is set by a home-information-server company, provides such services as control of operation of the equipment 120 from the user terminal 110 or access to a file existing in the recording medium 130 (step S140), whereby the users can enjoy the services at the user terminal 110 (step S150). Hereinafter such a system will be adopted as the change of setting of the home information server 100 is performed by a home-information-server company at the request of the administrator of the home information server to the home-information-server company.

In the network information for each home, the set file name is stated as setting information or configuration information. When the configuration of the internal network is changed, all or part of the set file would be transmitted to the home information server 100.

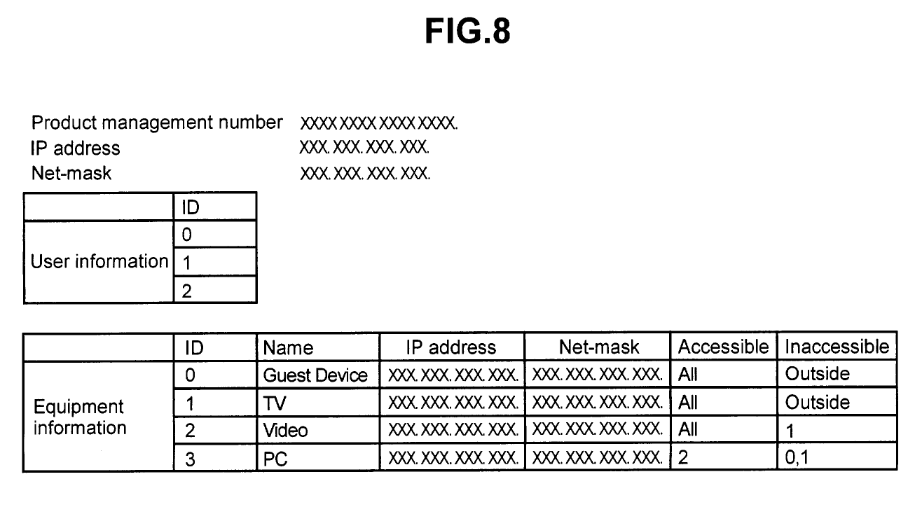

The details of setting a home information server will be explained referring to FIG. 8. FIG. 8 shows an example of a set file. In the set file, items as shown below are contained: the items concerning the home information server such as the product management number of the home information server, an IP address which is a number for identifying the home information server on the network, and a net-mask which shows the range in the network in which direct communication is possible and besides the items shown in the above the user ID's joining the network and the network setting information of the equipment.

The management of users in the network is performed inside the home information server in each home, so that the information owned by the company may be only user ID numbers. However, the company may own the names of users. On the other hand, the information of the equipment connected to the network is managed en bloc by the home information server on the side of a company. The information to be managed includes IP address, the information for identifying the equipment, the net-mask showing the accessible range of the equipment, a user ID indicating users having access to a given device, and a user ID indicating users have been denied access to a given device.

The access means to be able to communicate with the equipment through the connection thereto, further it also means to be able to transmit control signals to the equipment. Therefore, there are various kinds of cases as shown below. For example, management can be carried out such that all control signals transmitted from a user ID to equipment are refused; management can be carried out such that all control signals transmitted from a user ID to equipment are permitted; management can be carried out such that part of control signals transmitted from a user ID to equipment is permitted and the remainder is refused.

In one implementation, the setting file shown in FIG. 8 exists in two places, in the home information server 100 and the terminal of home-information-server company 300. The updating of a setting file is performed at the terminal of home-information-server company 300, and the changed portion is transmitted to the home information server 100. For example, in a case where a user ID=0 is to be added as an accessible user to a PC of the equipment information shown in FIG. 8, from the terminal of home-information-server company 300 transmits the ID number (3) of the equipment information, the accessible user ID (0, 2) after the change and a user ID (1) which refuses access to the home information server 100.

Next, the authority of general users in the internal network 140 will be explained.

General users who are able to access the equipment or files in the internal network 140 are generated by the home-information-server administrator. This is carried out by the users having access to the equipment connected to the internal network and the updating of the user information showing the administrator. The authentication of general users is performed in the home information server 100, and there is no need to transmit it to the outside. The general users are able to access the equipment in the network under the limitation set for each user in the home information server 100 and they are able to make or update files in the recording terminal. The files made for oneself can be open to the public, and the permission to read or update the files can be given to the others.

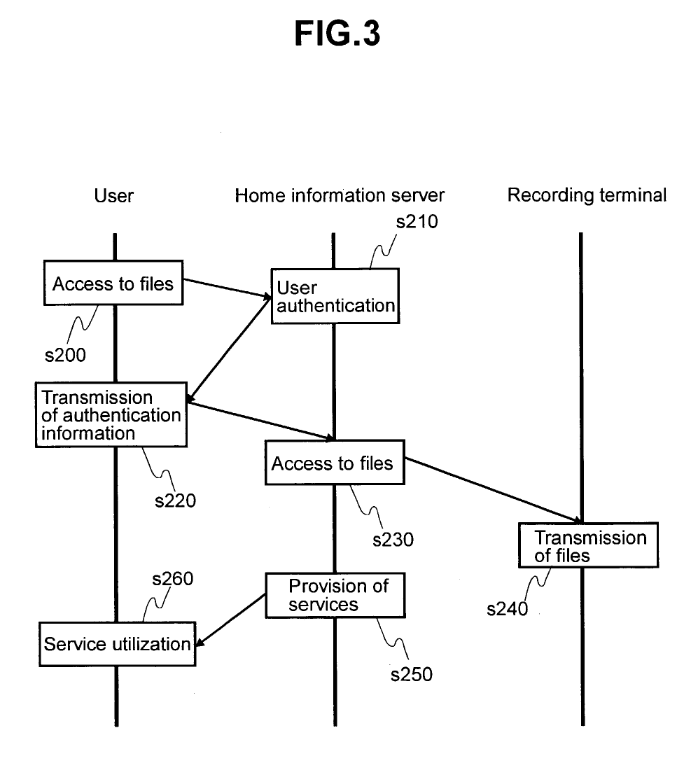

The file access of general users will be explained referring to FIG. 3. A user requests access to the recording medium 130 (e.g., a given file therein) via the user terminal 110 (step S200). The home information server 100 processes the user request to determine whether a user authentication is required to access the recording medium or a given file therein and determines whether (step S210).

If the requested access requires authentication, the user is asked to provide an appropriate authentication. Thereupon, the user transmits the authentication information to the home information server (step S220). If not, the request may be granted without requesting authentication information from the user.

The home information server 100 examines the authentication information and retrieves the requested file from the recording medium if the authentication has been successfully made (step S230). The home information server 100 transmits the file to the user or to a device or terminal designated by the user (step S240). Thus the user uses the transmitted file (steps S250 and S260).

The authentication of users is performed as shown in the following. That is, the home information server stores user information indicating the authorized users and administrator in the internal network. The home server verifies the information sent by the requesting user against the authentication information contained in the user information, so as to perform the authentication of the requesting user.

The authentication of a requesting user may be made each time the user requests an access to a file. Once the authentication of a user has been completed, the equipment that is controlled by the user may store the authentication information and automatically send it to the home information server as required.

The home information server stores the data of user authority information that shows that whether it should allow a control signal transmitted from the equipment controlled by a user or an administrator to the other equipment through the home information server to pass therethrough or not. When a user controls a certain unit of equipment to transmit a control signal to another unit of equipment, the control signal is, at first, input to the home information server and it determines whether the control signal shall be allowed to pass therethrough or not based on the user authority information. The determination is performed according to a kind of user or signal. For example in a family, it is possible to so arrange the system that a control signal transmitted from a PC owned by a child to a PC owned by his parent is not able to pass the home information server. Or for example, it is also possible to so arrange the system that when a control signal transmitted from a PC owned by a child to the database commonly owned by all of the family is used for reading-out the data, the control signal is able to pass the home information server, but when the control signal is used for deleting any data, it is unable to pass the home information server. On the other hand, when a transmitter of the control signal is the administrator, the system may be so arranged that all control signals for every unit of equipment are able to pass the home information server.

It is also possible, after user authentication, to determine whether the user is able to access the file or not. In other words, every file is previously provided with the attribute information showing users who are able to control the inspection, updating, or deletion of the file. The home information server reads the attribute information and judges if the user is able to inspect, renew or delete the file.

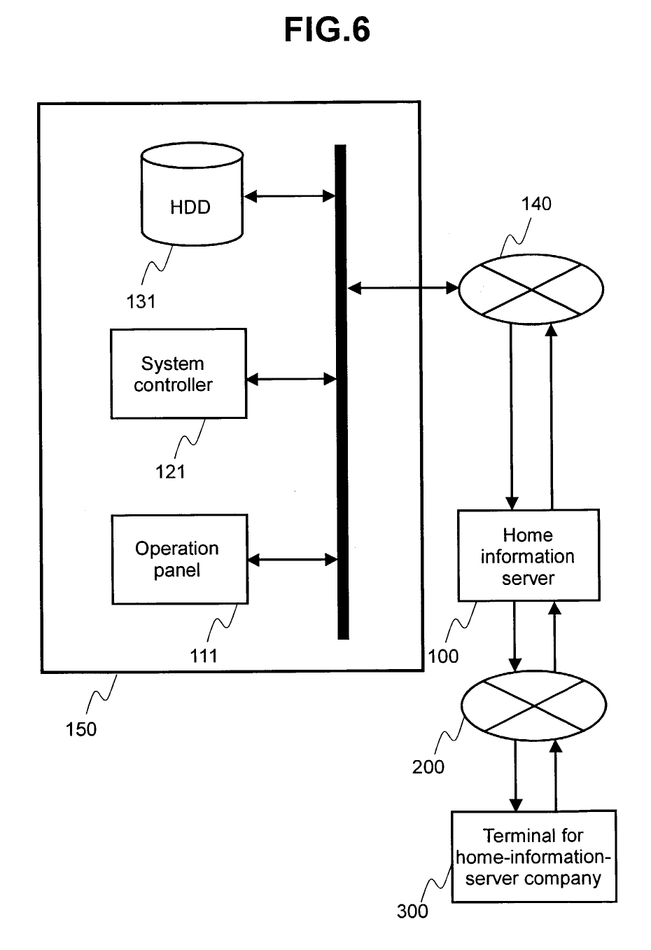

Next, the case where the configuration shown in FIG. 1 is embodied with an HDD recorder will be explained referring to FIG. 6. In FIG. 6, to like parts with those shown in FIG. 1, like reference numerals are given and the explanation thereof are omitted.

The HDD recorder 150 is connected to the internal network 140 to record and playback video. The HDD recorder may be directly connected to the home information server 100. A control panel 111 being a control means corresponding to the user terminal 110 shown in FIG. 1, and allows users to operate the HDD recorder 150. A system controller 121 including read-out control means corresponds to the equipment 120 shown in FIG. 1 and controls the HDD recorder 150 to specially write or read the information onto or from an HDD 131. The HDD 131 corresponds to the recording medium 130 shown in FIG. 1, and stores recorded video and outputs data upon a playback request.

The process for obtaining an access to the HDD recorder 150 is similar to that explained in connection with FIG. 3. [Correct?] For example, to watch a video file stored in the HDD 131, a user instructs playback through the operation panel 111. The home information server 100 performs an appropriate authentication step. If authentication has been successful, the user's request is forwarded to the system controller 121 by the home server 100. The system controller 121 plays back the video data according to a file address provided by the home information server 100. If the authentication has not successful, the user request would not be forwarded to the system controller 121, thereby denying the user from accessing the video data. In one implementation, the home server 100 and the HDD recorder 150 are combined in a single device. The home server 100 may be provided in other consumer electronic products, e.g., in a digital television.

As mentioned in the above, the explanation is given to the first embodiment according to the present invention, for a method of configuring the home information server 100 and the authority of the administrator of a home information server and the authority of the general users. The present embodiment produces the effects as mentioned in the following.

Since the administrator of the home information server entrusts the home-information-server company with the setting of the internal network, the security level of each internal network is able to keep a certain level irrespective of the degree of skill of the administrator of the home information server.

Since the authentication of the general users is performed within the internal network, an unauthorized third party access of this sensitive information is reduced.

As mentioned in the above, the security of the internal network 140 is managed by a professional security service vendor (e.g., the manufacturer of the home information server) so more reliable security could be obtained than that provided if consumers themselves performed the security configuration and management thereof. Next, a second embodiment according to the present invention will be explained. In the present embodiment, the method of approval of an administrator of a home information server will be described. The configuration of the network is the same as that of the first embodiment shown in FIG. 1, and the explanation thereof will be omitted.

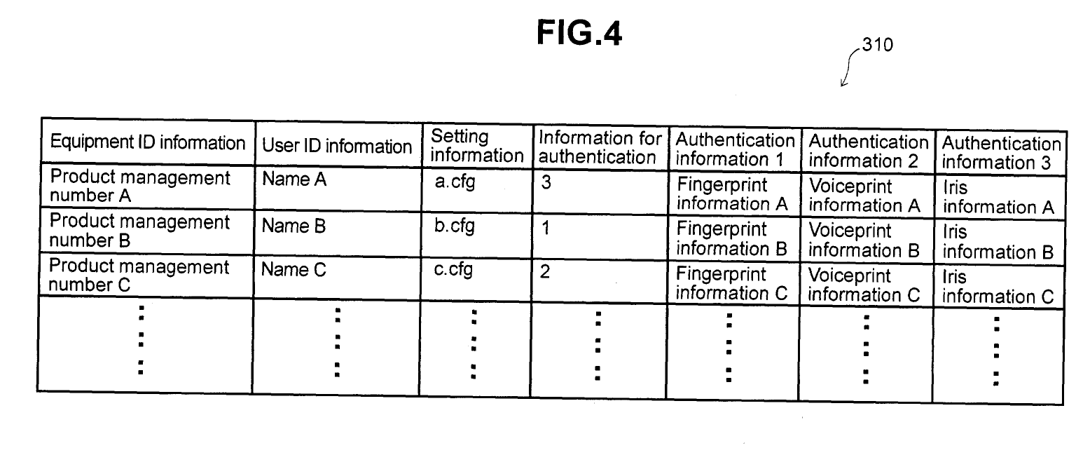

FIG. 4 is a diagram showing a database 310 (see, FIG. 1) on the administrators of home information servers managed by of a home information server company. The company generally communicates with the home server 100 via a company server provided at a remote location from the home server. The term “home information server company” or “terminal for a home-information-server company” is also referred to as a “company server” or “remote server”. Similarly, the terms “company server” and “remote server” also are used to refer to the “home information server company” or a terminal thereof.

The database 310 is provided in a storage area associated with the terminal 300 of a home information server company. The terminal includes a recording medium such as an HDD. The database 310 comprises equipment identification information, user identification information, information for authentication, authentication information 1, authentication information 2 and authentication information 3. In this place, three types of biological information are shown as authentication information, but the authentication information may be one or more, and the authentication may be of other types such as a password, etc. other than the biological information.

When authentication is requested from an administrator of a home information server, the home-information-server company checks the equipment identification number of the home information server 100 that has requested the authentication through the external network 200, and from the database 310 checks the corresponding line. Next, authentication is performed with the use of authentication information corresponding to the number written in the information for the authentication. Referring to FIG. 4, for a product number A, authentication is performed with the use of the iris information A for a given instance; for a product number B, authentication is performed with the use of the finger print information B. At another instance, the authentication information used for the product A may be finger print and the product B may be the iris information. The use of authentication information for a given product at a given time may be selected randomly from a plurality of authentication information types.

In the second embodiment according to the present invention, authentication is performed with the combined use of the equipment identification number of the home server and the authentication information of the administrator of the home server, whereby even in a case where the authentication information possessed by the administrator of the home server is compromised, the damage can be limited to the range of a home information server having the corresponding product management number. By changing the authentication information that is necessary for authentication at a proper timing, it is made possible to prevent gaining of an unauthorized, illegal access to the home information server by a third party.

Next a third embodiment will be explained. In the present embodiment, the handling of a user, equipment or an application that is not registered to the internal network will be described. The configuration of the network is the same as that shown in the first embodiment shown in FIG. 1, and the explanation thereof will be omitted.

When using the service available in the internal network, a person who is not registered in the internal network may be authenticated as a guest user. The guest user is not asked to provide authentication information, e.g., password or biological information, to access the equipment 120 in one implementation. Rather, he is subjected to a use certain limitation, as specified by the administrator of the home information server. For example, the guest user is authorized to read-out data in a file of a video recording device but cannot write into the recording device. Alternatively, the guest user may be asked to provide authentication information, e.g., password, to register in as a guest user, whereby he may have restricted access to the equipment 120, as specified by the administrator of the home server. Likewise, any electronic device that is not registered to the internal network or home server is provided with limited to access the electronic device that is registered with the internal network or home server. This prevents unauthorized copying of data from the equipment 120 or other use of the equipment 120 by a third party.

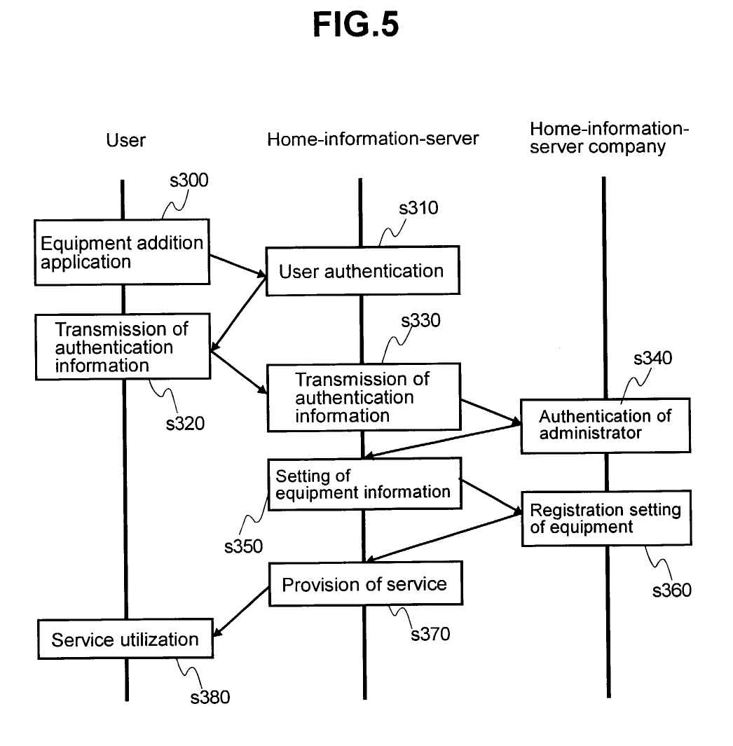

FIG. 5 shows a process for registering an electronic device according to one embodiment of the present invention.

A user who is an administrator requests registration of an electronic device (equipment 120) to the home information server 100 using the user terminal 110 (step S300). The home information server requests authentication information associated with adding a new device (step S310). The user inputs authentication information including the administrator information on the home information server 100 to the remote server 300 via the home server (step S320). The authentication information is transmitted from the home server 100 to the remote server 300 (step S330). The remote server or a related entity thereof authenticates the administrator of the home information server (step S340). After receiving the confirmation of authentication, the home information server 100 transmits the equipment information to the remote server 300 (step S350). The remote server 300 registers or associates the electronic device to the home information server 100 (step S360). In other word, the new electronic device is added to the setting information shown in FIG. 8. Thereafter, the home information server indicates to the user terminal 110 that the new electronic device has been registered and ready for service. (step S370). The user may then commence using the new electronic device (step S380). When a user intends to newly add an application program to the equipment, the same procedures as mentioned in the above are requested.

The home information server stores connected-equipment information that includes the information concerning the network configuration of the equipment connected to the internal network. More specifically, the home information server stores the information relating to what kind of, how many units of equipment are connected to the internal network. The connected-equipment information may store another information concerning the network. Or the connected-equipment information can exist independently by itself or for example the setting information may also serve as the connected-equipment information.

For simplification the explanation of the following has been omitted in the above explanation, but it is recommendable to encode the data (authentication information, setting requests, setting information, etc.) to be exchanged between the home information server and the center. In order to prepare such a system, cipher means or cryptography systems or devices are provided in the internal network (i.e., coupled to the home information server) and the home information company site (i.e., coupled to the remote server) to securely exchange data.

In one embodiment, the home-information-server company 300 provides the above services for certain amounts of money. In other words, the information center stores the connected-equipment information concerning the network configuration of the equipment connected to the internal network, and according to the connected-equipment information the information center is able to do the billing. For example, the company 300 charges a basic fee for selected services. The basic fee can be a monthly fee for registering and using n number of electronic devices in association with the home server. Additional fees may be charged for additional services including registering and using more than n number of devices.

The other method of billing is shown below. The information center stores home information server-receiving-data-amount information indicating the amount of data that is transmitted from the external network, and the billing can be done according to the receiving-data-amount information of a home information server. With the additional security level provided by the embodiments described herein, interested parties may exchange sensitive data without worrying about the security being compromised.

In the above explanation, a system configuration is explained in which the home information server transmits the authentication information and the setting request to the center. However, an external terminal (not shown) connected to the external network may transmit the authentication information and the setting request to the center. In such a case, the administrator of the internal network operates the external terminal to transmit the authentication information and the setting request to the center. In order that the home information server is able to confirm the authentication of the authentication information at the center, it is also possible to transmit the authentication-confirmation information showing that the authentication information is authenticated from the center to the home information server. Thus, it is possible to holdback such a case where one under the disguise of the administrator of the internal network transmits a setting request of a home information server through the external terminal and improperly changes the setting of the home information server.

In the above, the configuration in which the authentication information and the setting request are directly sent to the information center from the external terminal is explained; however the above operation may be done through a home information server. In other words, the authentication information and the setting request can be transmitted from the external terminal to the home information server, the home information server performs authentication based on the received authentication information and transmits the received authentication information and the setting request to the center. The center performs the authentication of the administrator based on the authentication information, and in a case where the authentication is properly authenticated, the setting information is transmitted to the home information server. This configuration gives the same effect as the above-mentioned configuration.

The above detailed descriptions are provided to illustrate specific embodiments of the present invention and are not intended to be limiting. Numerous modifications and variations within the scope of the present invention are possible. Accordingly, the present invention is defined by the appended claims.

What is claimed is:

1. A method for managing a network system including at least one host system and a registration server provided at a remote location from the at least one host system, the at least one host system and the registration server being coupled to each other by a communication link, the method comprising:
receiving at the registration server a first request to register a first administrator of a first host system, the first administrator being provided with authority to control access to the first host system by one or more users, the first host system being associated with a first entity;
authenticating validity of the first registration request at the registration server, the first registration request being considered valid if valid first authorization information is provided to the registration server in connection with the first registration request, the registration server being associated with an entity that is different from the first entity; and
registering the first administrator as an administrator of the first host system upon successfully authenticating the first registration request.

2. The method of claim 1, further comprising:
receiving at the registration server a second request to register a second administrator of a second host system, the second administrator being provided with authority to control access to the second host system by one or more users, the second host system being associated with a second entity, the second entity being different from the first entity and the entity associated with the registration server;
authenticating validity of the second registration request at the registration server, the second registration request being considered valid if valid second authorization information is provided to the registration server in connection with the second registration request; and
registering the second administrator as an administrator of the second host system upon successfully authenticating the second registration request.

3. The method of claim 2, wherein the first host system includes a first host server that is coupled to the registration server, the first host server being configured to transmit the first registration request.

4. The method of claim 3, wherein the first host system includes a first electronic device coupled to the first host server, the first administrator being provided with authority to control access to the first electronic device by one or more users, wherein the first electronic device is configured to be accessed from within the host system or from without via the external network, or both.

5. The method of claim 4, wherein the first host system is a home network system and the first entity is an individual.

6. The method of claim 5, wherein the second host system is a business network system and the second entity is a commercial entity.

7. The method of claim 1, further comprising:
receiving a request to associate a first electronic device to the first host system to enable the first administrator to control access to the first electronic device by one or more users; and
authenticating at the registration server the request to associate the first electronic device to the first host system.

8. The method of claim of 7, further comprising:
storing in the registration server first security information and second security information that are associated with the first administrator;
selecting randomly one of the first and second security information associated with the first administrator; and
transmitting a request to the first host system to provide the one of the first and second security information that has been selected to authenticate the request to associate the first device to the first host system.

9. The method of claim 1, wherein the entity associated with the registration server charges a certain amount of fee from the first entity for handling the registration request from the first host system, wherein the first administrator of a first host system is a user or a computer readable program.

10. A method for managing a host system coupled to a registration server provided at a remote location from the host system, the host system and the registration server being coupled to each other by a communication link, the method comprising:
transmitting a registration request for registering a first administrator of the host system to the registration server, the first administrator being provided with authority to control access to the host system by one or more users, the host system being associated with a first entity;
providing authorization information to authenticate the registration request to the registration server, the registration server being associated with an entity that is different from the first entity, the registration server being configured to authenticate requests to register administrators of a plurality of host systems, each of the plurality of host systems being associated with a different entity from each other and the entity associated with the registration server; and
receiving approval of the registration request from the registration server.

11. The method of claim 10, wherein the host system includes a host server that is coupled to the registration server and a first electronic device that is coupled to the host server via an internal network, the first administrator controlling access to the first electronic device by one or more users of the first electronic device.

12. The method of claim 11, further comprising:
receiving at the host server a request to access the first electronic device from a user;
authenticating the request to access the first electronic device based on user authentication information provided in connection with the request to access the first electronic device; and
granting access to the first electronic device if the user authentication information provided in connection with the access request is determined to be valid.

13. The method of claim 12, further comprising:
determining whether the request to access to the first electronic device requires an authentication process; and
requesting user authentication information from the user if it is determined that the authentication process is required to grant access to the first electronic device.

14. The method of claim 11, wherein the host system further includes a second electronic device configured to reproduce video data or reproduce audio data, or both, wherein the second electronic device and the host server is the same device.

15. The method of claim 10, further comprising:
transmitting a request to associate a first electronic device to the host system to enable the first administrator to control access to the electronic device by one or more users;
providing authentication information to the registration server; and
receiving an approval of the request to associate the first electronic device to the first host system.

16. A host server provided in a host system for managing access to the host system, the host server being coupled to a remote registration server, the host server comprising:
a first communication interface coupled to an internal network provided within the host system;
a second communication interface coupled to an external network, the external network coupling the host server to the remote registration server;
an information processing unit to process requests received from the internal network or from a user terminal regarding access to one or more electronic devices provided within the host system; and
a computer readable medium including
code for transmitting a request to register a first administrator of the host system to the remote registration server, the first administrator being provided with authority to control access to the host system by one or more users;
code for providing authorization information to authenticate the request to register the first administrator to the remote registration server; and
code for receiving approval of the request to register the first administrator from the registration server,
wherein the host system is associated with a first entity and the remote registration server is associated with a second entity different from the first entity.

17. The host server of claim 16, wherein the registration server is configured to authenticate requests to register administrators of a plurality of host systems, each host system of the plurality of host systems being associated with a different entity from each other.

18. The host server of claim 16, wherein the computer readable medium further includes:
code for receiving a request to access a first electronic device provided within the host system from a user;
code for authenticating the request to access the first electronic device based on user authentication information provided in connection with the request to access the first electronic device;
code for granting access to the first electronic device if the user authentication information provided in connection with the access request is determined to be valid;
code for transmitting a request to associate a second electronic device to the host system to enable the first administrator to control access to the second electronic device by one or more users;
code for providing authentication information to the remote registration server; and
code for receiving an approval of the request to associate the second electronic device to the host system.

19. The host server of claim 17, wherein the host system is a home network system and the first entity is an individual.

20. A network system, comprising:
a first host system including a first host server and a first electronic device coupled to the first host server via a first internal network, the first host system being associated with a first administrator having authority to control access to the first host system by one or more users, the first host system being associated with a first entity;
a second host system including a second host server and a second electronic device coupled to the second host server via a second internal network, the second host system being associated with a second administrator having authority to control access to the second host system by one or more users, the second host system being associated with a second entity;
a remote management server coupled to the first and second host systems via an external network, the remote management server including first authentication information used for authenticating a request from the first administrator relating to the first host system and second authentication information used for authenticating a request from the second administrator relating to the second host system, the remote management server being associated with a third entity,
wherein the first, second, and third entities are different entities from each other.
